(19) United States
(12) Patent Application Publication
(10) Pub. No.: US 2017/0171496 A1
(43) Pub. Date: Jun. 15, 2017

(54) Method and Electronic Device for Screen Projection

(71) Applicants: Le Holdings (Beijing) Co., Ltd., Beijing (CN); LE SHI INTERNET INFORMATION & TECHNOLOGY CORP., BEIJING, Beijing (CN)

(72) Inventor: Xiang Qu, Beijing (CN)

(21) Appl. No.: 15/242,533

(22) Filed: Aug. 21, 2016

Related U.S. Application Data
(63) Continuation of application No. PCT/CN2016/089544, filed on Jul. 10, 2016.

(30) Foreign Application Priority Data
Dec. 15, 2015 (CN) 2015109314121

(51) Int. Cl. H04N 5/46; H04L 29/08; H04N 9/31

(52) U.S. Cl. CPC H04N 5/46; H04N 9/3147; H04L 67/10; H04L 67/141

(57) ABSTRACT

The present disclosure relates to the communications field, and disclose a screen projection method and electronic device. The method includes: disposing a screen projection interface on multiple terminals, interconnecting the screen projection interface of each terminal by a network, where the network is not a local area network, and a source terminal sending screen projection data to a target terminal by the screen projection interface. The foregoing technical solution, by disposing screen projection interfaces in different networks, may implement a screen projection from a source terminal to a target terminal by a screen projection interface, and resolve the problem of a cross-network segment screen projection.

### CROSS-REFERENCE TO RELATED APPLICATIONS

The present application is a continuation of PCT application No. PCT/CN2016/089544 submitted on Jul. 10, 2016, and claims priority to Chinese Patent Application No. 201510931412.1, filed with the Chinese Patent Office on Dec. 15, 2015 and entitled “SCREEN PROJECTION METHOD,” which is incorporated herein by reference in its entirety.

### TECHNICAL FIELD

The present disclosure relates to the communications field, and in particular, to a screen projection method and electronic device.

### BACKGROUND

In a wireless local area network, screen projection may be implemented among different terminals. For example, a screen projection between an Apple device and a set-top box or a television with an Airplay function may be implemented by Airplay.

The Digital Living Network Alliance (DLNA) is a set of protocols for interconnection and intercommunication among PCs, mobile devices and consumer appliances proposed by Sony, Intel, and Microsoft, etc. Their aim is to “enjoy music, photos and videos anytime anywhere.” Some player APPs of the Android system have the DLNA function. For example, Tencent Video, Sohu Video and Thunder KanKan have such a function. Movies that are originally supposed to be on a mobile phone screen can be transferred to and displayed on a smart television or a set-top box. This screen projection solution requires a mobile phone to support the DLNA function, and the mobile phone and a smart television are required to be arranged in the same local area network.

Limited by the local area network, the existing screen projection fails to implement a cross-network segment screen projection, and cannot satisfy requirements of users.

So far, there is no solution to the foregoing problems in prior art.

### SUMMARY

The present disclosure provides a screen projection method and electronic device, where the screen projection method can implement a cross-network segment screens projection.

On a first aspect, some embodiments of the present disclosure provides a screen projection method, where the method includes: disposing a screen projection interface on multiple terminals; interconnecting the screen projection interface of each terminal by a network, where the network is not a local area network; and a source terminal sending screen projection data to a target terminal by the screen projection interface.

On a second aspect, some embodiments of the disclosure further provides a non-volatile computer storage medium, which stores a computer executable instruction, where the computer executable instruction is used to execute any of the foregoing screen projection methods of the disclosure.

On a third aspect, some embodiments of the disclosure further provides an electronic device, including: at least one processor; and a memory, where the memory stores a program that can be executed by the at least one processor, and the instruction is executed by the at least one processor, so that the at least one processor can execute any of the foregoing screen projection methods of the disclosure.

Other features and advantages of the present disclosure are described in detail in the following specific embodiments.

### BRIEF DESCRIPTION OF THE DRAWINGS

One or more embodiments are exemplarily described by figures corresponding thereto in the accompanying drawings, and the exemplary descriptions do not constitute a limitation on the embodiments. Elements with the same reference numbers in the accompanying drawings represent similar elements. Unless otherwise particularly stated, the figures in the accompanying drawings do not constitute a scale limitation.

FIG. 1 is a flowchart of a screen projection method according to some embodiments of the present disclosure; and

FIG. 2 is a schematic structural diagram of hardware of a device for executing a screen projection method according to some embodiments of the present disclosure.

### DETAILED DESCRIPTION

Specific embodiments of the present disclosure are described in detail with reference to the accompanying drawing. It should be understood that the specific embodiments described herein are merely for the purpose of describing and explaining the present disclosure, rather than limiting the present disclosure.

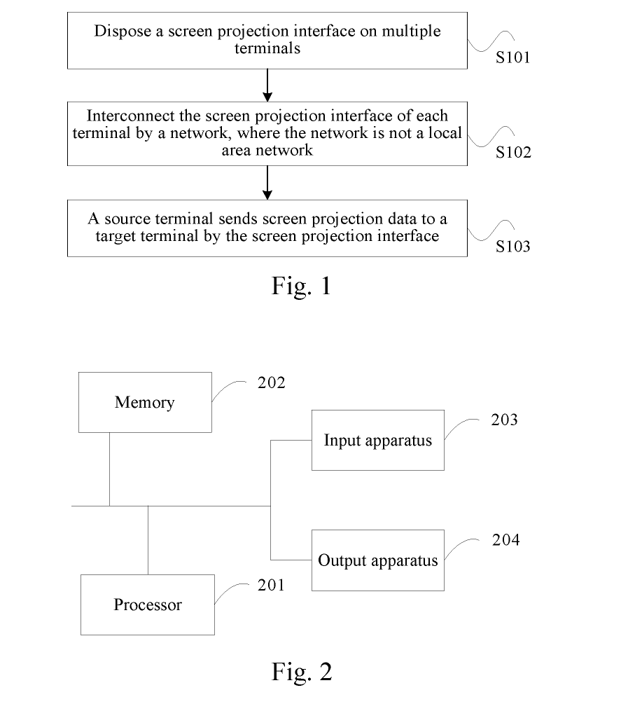

FIG. 1 is a flowchart of a screen projection method according to some embodiments of the present disclosure. As shown in FIG. 1, the present disclosure provides a screen projection method, where the method includes: S101, disposing a screen projection interface on multiple terminals; S102, interconnecting the screen projection interface of each terminal by a network, where the network is not a local area network; and S103, a source terminal sending screen projection data to a target terminal by the screen projection interface. The foregoing technical solution, by disposing screen projection interfaces in different networks, can implement a screen projection from a source terminal to a target terminal by a screen projection interface.

In an embodiment, the step of a source terminal sending screen projection data to a target terminal by a screen projection interface may include the following steps:

the source terminal sending a screen projection request aiming at the target terminal to the screen projection interface;

the target terminal sending a screen projection response to the source terminal in response to the screen projection request; and

the source terminal sending the screen projection data to the target terminal in response to the screen projection response.

In the foregoing embodiment, the source terminal may be a mobile phone used by a user, for example, a smartphone; and the target terminal may be a networking device such as a tablet computer, a smart television, a network set-top box and other smart mobile phones.

The source terminal establishes a communication link from the source terminal to the target terminal after receiving the screen projection response. The communication link may be used to transmit screen projection data from the source terminal to the target terminal. In an embodiment, the communication link may be further used by the source terminal to send a control signal by the communication link to the target terminal to control an action of the target terminal. In such an embodiment, it may be assumed that the source terminal is a smartphone and the target terminal is a smart television, and after a communication link between the smartphone and the smart television is established, a user may control the smart television with the smartphone, using the smartphone as a television remote control. While being used as a remote control, the smart phone may send the screen projection data corresponding to content to be projected on screen to the target terminal (for example, the smart television) by the screen projection interface.

In another embodiment, the method may further include:

the source terminal broadcasting the screen projection request aiming at the target terminal by the screen projection interface;

the target terminal sending the screen projection response to the source terminal in response to the screen projection request; and

the source terminal sending the screen projection data to the target terminal in response to the screen projection response.

In an embodiment, the source terminal may add an address of the target terminal to the screen projection request, and then broadcast the screen projection request to multiple terminals by the screen projection interface. After receiving the screen projection request, each terminal may determine whether to respond to the screen projection request according to the address of the target terminal included in the screen projection request. The foregoing method may implement a screen projection from a source terminal to a specific target terminal.

In an embodiment, each of the multiple terminals scans the screen projection interface at a preset interval (for example, 50 ms). In an embodiment, the multiple terminals may be associated with user identities. In such an embodiment, a user identity may be associated with a specific screen projection interface, and a terminal bound to a user identity may be installed with the screen projection interface associated with the bound user identity. The associating the multiple terminals with user identities includes: binding the user identities to the multiple terminals.

In the foregoing embodiments, the source terminal and the target terminal may communicate in a wired and/or wireless manner. In an embodiment, the source terminal is a radio transmitting/ receiving unit.

In an implementable embodiment, the foregoing method may further include mapping an address of a device inside a local area network to an external network by port mapping. Port mapping is to map a port of an IP (Internet Protocol) address of a host machine in an external network to a machine in an internal network and provide a corresponding services. When a user accesses the port of the IP, a server automatically maps the request to a machine inside a corresponding local area network. Port mapping includes dynamic port mapping and static port mapping.

The port mapping is to map a local area network (LAN) IP address of a host machine to a wide area network (WAN) IP address. When a user accesses a port of a host machine that provides a port for mapping, a server transfers the request to a host machine inside the local area network that provides such specific services. By means of port mapping function, multiple ports of a machine with an external network IP address may be mapped to different ports of different machines in an internal network. The port mapping function may also complete some specific proxy functions, for example, a proxy for protocols like POP, SMTP, TELNET and so on.

The foregoing technical solution, by disposing a screen projection interface in different networks, may implement a screen projection from a source terminal to a target terminal by a screen projection interface, and resolve the problem of a cross-network segment screen projection.

The disclosure further provides a non-volatile computer storage medium, which stores a computer executable instruction, where the computer executable instruction can execute the screen projection method of any of the foregoing method embodiments of the disclosure.

FIG. 2 is a schematic structural diagram of hardware of a device for executing a screen projection method provided by some embodiments of the disclosure. As shown in FIG. 2, the device includes:

one or more processors 201 and a memory 202, with one processor 201 as an example in FIG. 2.

A device for executing the screen projection method may further include: an input apparatus 203 and an output apparatus 204.

The processor 201, the memory 202, the input apparatus 203, and the output apparatus 204 can be connected by means of a bus or in other manners, with a connection by means of a bus as an example in FIG. 2.

As a non-volatile computer readable storage medium, the memory 202 can be used to store non-volatile software programs, non-volatile computer executable programs and modules, for example, a program instruction/module corresponding to the screen projection method in the embodiments of the disclosure. The processor 201 executes various functional applications and data processing of the server, that is, implements the screen projection method of the foregoing method embodiments, by running the non-volatile software programs, instructions, and modules stored in the memory 202.

The memory 202 may include a program storage area and a data storage area, where the program storage area may store an operating system and at least one application needed by function; the data storage area may store data created according to use of a processing apparatus of the screen projection method, and the like. In addition, the memory 202 may include a high-speed random access memory, and also may include a non-volatile memory, such as at least one disk storage device, flash storage device, or other non-volatile solid-state storage devices. In some embodiments, the memory 202 optionally includes memories remotely disposed with respect to the processor 201, and the remote memories may be connected, via a network, to the processing apparatus of the screen projection method. Examples of the foregoing network include but are not limited to: the Internet, an intranet, a local area network, a mobile communications network, and a combination thereof.

The input apparatus 203 can receive entered digit or character information, and generate key signal inputs relevant to user setting and functional control of the processing apparatus of the screen projection method. The output apparatus 204 may include a display device, for example, a display screen, etc.

The one or more modules are stored in the memory 202, and execute the processing method of the screen projection method in any one of the foregoing method embodiments when being executed by the one or more processors 201.

The foregoing product can execute the method provided in the embodiments of the disclosure, and has corresponding functional modules for executing the method and beneficial effects. The method provided in the embodiments of the disclosure can be referred to for technical details that are not described in detail in the embodiment.

The electronic device in the embodiment of the disclosure exists in multiple forms, including but not limited to:

(1) Mobile communication device: such devices being characterized by having a mobile communication function and a primary objective of providing voice and data communications; such type of terminals including a smart phone (for example, an iPhone), a multimedia mobile phone, a feature phone, a low-end mobile phone, and the like;

(2) Ultra mobile personal computer device: such devices belonging to a category of personal computers, having computing and processing functions, and also generally a feature of mobile Internet access; such type of terminals including PDA, MID and UMPC devices, and the like, for example, an iPad;

(3) Portable entertainment device: such devices being capable of display and play multimedia content; such type of devices including an audio and video player (for example, an iPod), a handheld game console, an e-book, an intelligent toy and a portable vehicle-mounted navigation device;

(4) Server: a device that provides a computing service; the components of the server including a processor, a hard disk, a memory, a system bus, and the like; an framework of the server being similar to that of a general-purpose computer, but higher demanding in aspects of processing capability, stability, reliability, security, extensibility, manageability or the like due to a need to provide highly reliable services; and

(5) Other electronic apparatuses having a data interaction function.

The apparatus embodiments described above are merely schematic, and the units described as separated components may or may not be physically separated; components presented as units may or may not be physical units, that is, the components may be located in one place, or may be also distributed on multiple network units. Some or all modules therein may be selected according to an actual requirement to achieve the objective of the solution of the embodiment.

Through descriptions of the foregoing implementation manners, a person skilled in the art can clearly recognize that each implementation manner can be implemented by means of software in combination with a general-purpose hardware platform, and certainly can be also implemented by hardware. Based on such an understanding, the essence or a part contributing to the relevant technologies of the foregoing technical solutions can be embodied in the form of a software product. The computer software product may be stored in a computer readable storage medium, for example, a ROM/RAM, a magnetic disk, a compact disc or the like, including several instructions for enabling a computer device (which may be a personal computer, a sever, or a network device, and the like) to execute the method described in the embodiments or in some parts of the embodiments.

Finally, it should be noted that the foregoing embodiments are only for the purpose of describing the technical solutions of the disclosure, rather than limiting thereon. Although the disclosure has been described in detail with reference to the foregoing embodiments, a person of ordinary skill in the art should understand that he/she can still modify technical solutions disclosed in the foregoing embodiments, or make equivalent replacements to some technical features therein, while such modifications or replacements do not make the essence of corresponding technical solutions depart from the spirit and scope of the technical solutions of the embodiments of the disclosure.

What is claimed is:

1. A screen projection method applied in a terminal, comprising:
disposing a screen projection interface on multiple terminals;
interconnecting the screen projection interface of each terminal by a network, wherein the network is not a local area network; and
a source terminal sending screen projection data to a target terminal by the screen projection interface.

2. The method according to claim 1, wherein the source terminal sending screen projection data to a target terminal by the screen projection interface comprises:
the source terminal sending a screen projection request aiming at the target terminal to the screen projection interface;
the target terminal sending a screen projection response to the source terminal in response to the screen projection request; and
the source terminal sending the screen projection data to the target terminal in response to the screen projection response.

3. The method according to claim 2, wherein the source terminal establishes a communication link from the source terminal to the target terminal after receiving the screen projection response.

4. The method according to claim 3, wherein the source terminal sends a control signal to the target terminal by the communication link to control an action of the target terminal.

5. The method according to claim 1, wherein the method comprises:
the source terminal broadcasting the screen projection request aiming at the target terminal by the screen projection interface;
the target terminal sending the screen projection response to the source terminal in response to the screen projection request; and
the source terminal sending the screen projection data to the target terminal in response to the screen projection response.

6. The method according to claim 1, wherein the method comprises:
the source terminal sending the screen projection data corresponding to content to be projected on screen to the target terminal by the screen projection interface.

7. The method according to claim 1, wherein the method comprises:
each terminal scanning the screen projection interface at a preset interval.

8. The method according to claim 1, wherein the method comprises:
associating the multiple terminals with user identities.

9. The method according to claim 8, wherein the associating the multiple terminals with user identities comprises: binding the user identities to the multiple terminals.

10. A non-volatile computer storage medium, stored with a computer executable instruction when executed by an electronic device, cause the electronic device to:
dispose a screen projection interface on multiple terminals;
interconnect the screen projection interface of each terminal by a network, where the network is not a local area network; and
a source terminal send screen projection data to a target terminal by the screen projection interface.

11. An electronic device, comprising:
at least one processor; and
the memory stores instructions that can be executed by the at least one processor, wherein execution of the instructions by the said at least one processor causes the at least one processor to:
dispose a screen projection interface on multiple terminals;
interconnect the screen projection interface of each terminal by a network, where the network is not a local area network; and
a source terminal send screen projection data to a target terminal by the screen projection interface.

12. The electronic device according to claim 11, wherein the execution of the instructions to send screen projection data to a target terminal by the screen projection interface cause the at least one processor to:
the source terminal send a screen projection request aiming at the target terminal to the screen projection interface;
the target terminal send a screen projection response to the source terminal in response to the screen projection request; and
the source terminal send the screen projection data to the target terminal in response to the screen projection response.

13. The electronic device according to claim 12, wherein the source terminal establishes a communication link from the source terminal to the target terminal after receiving the screen projection response.

14. The electronic device according to claim 13, wherein the source terminal sends a control signal to the target terminal by the communication link to control an action of the target terminal.

15. The electronic device according to claim 11, wherein the at least one processor is further caused to:
the source terminal broadcast the screen projection request aiming at the target terminal by the screen projection interface;
the target terminal send the screen projection response to the source terminal in response to the screen projection request; and
the source terminal send the screen projection data to the target terminal in response to the screen projection response.

16. The electronic device according to claim 11, wherein the at least one processor is further caused to:
the source terminal send the screen projection data corresponding to content to be projected on screen to the target terminal by the screen projection interface.

17. The electronic device according to claim 11, wherein the at least one processor is further caused to:
each terminal scan the screen projection interface at a preset interval.

18. The electronic device according to claim 11, wherein the at least one processor is further caused to:
associate the multiple terminals with user identities.

19. The electronic device according to claim 11, wherein the execution of the instructions to the associating the multiple terminals with user identities cause the at least one processor to comprises:
bind the user identities to the multiple terminals.

20. The electronic device according to claim 11, wherein the source terminal is a radio transmitting/receiving unit.
